(19) United States
(12) Patent Application Publication
(10) Pub. No.: US 2005/0261115 A1
(43) Pub. Date: Nov. 24, 2005

(54) Industrial roll with piezoelectric sensors for detecting pressure

(75) Inventors: Robert H. Moore, Pittsburgh, PA (US); Eric J. Gustafson, Winchester, VA (US); Balaji Srinivasan, Winchester, VA (US)

Correspondence Address: MYERS BIGEL SIBLEY & SAJOVEC, PO BOX 37428, RALEIGH, NC, 27627, US

(73) Assignee: Myers Bigel Sibley & Sajovec, P.A., Raleigh, NC (US)

(21) Appl. No.: 11/121,575

(22) Filed: May 4, 2005

Related U.S. Application Data
(60) Provisional application No. 60/571,401, filed on May 14, 2004.

(51) Int. Cl. B05C 1/08; B25F 5/02

(52) U.S. Cl. 492/10; 29/895.3; 29/895.23; 492/56; 492/9

(57) ABSTRACT

An industrial roll includes: a substantially cylindrical core having an outer surface; a polymeric cover circumferentially overlying the core outer surface, the cover including a base layer circumferentially overlying the core and a topstock layer overlying the base layer; and a sensing system. The sensing system includes: a plurality of piezoelectric sensors embedded in the cover base layer, the sensors configured to sense pressure experienced by the roll and provide signals related to the pressure; and a processor operatively associated with the sensors that processes signals provided by the sensors.

### RELATED APPLICATIONS

This application claims priority from U.S. Provisional Patent Application No. 60/571,401, filed 14 May 2004, the disclosure of which is hereby incorporated herein in its entirety.

### FIELD OF THE INVENTION

The present invention relates generally to industrial rolls, and more particularly to rolls for papermaking.

### BACKGROUND OF THE INVENTION

In a typical papermaking process, a water slurry, or suspension, of cellulosic fibers (known as the paper “stock”) is fed onto the top of the upper run of an endless belt of woven wire and/or synthetic material that travels between two or more rolls. The belt, often referred to as a “forming fabric,” provides a papermaking surface on the upper surface of its upper run which operates as a filter to separate the cellulosic fibers of the paper stock from the aqueous medium, thereby forming a wet paper web. The aqueous medium drains through mesh openings of the forming fabric, known as drainage holes, by gravity or vacuum located on the lower surface of the upper run (i.e., the “machine side”) of the fabric.

After leaving the forming section, the paper web is transferred to a press section of the paper machine, where it is passed through the nips of one or more presses (often roller presses) covered with another fabric, typically referred to as a “press felt.” Pressure from the presses removes additional moisture from the web; the moisture removal is often enhanced by the presence of a “batt” layer of the press felt. The paper is then transferred to a dryer section for further moisture removal. After drying, the paper is ready for secondary processing and packaging.

Cylindrical rolls are typically utilized in different sections of a papermaking machine, such as the press section. Such rolls reside and operate in demanding environments in which they can be exposed to high dynamic loads and temperatures and aggressive or corrosive chemical agents. As an example, in a typical paper mill, rolls are used not only for transporting the fibrous web sheet between processing stations, but also, in the case of press section and calender rolls, for processing the web sheet itself into paper.

Typically rolls used in papermaking are constructed with the location within the papermaking machine in mind, as rolls residing in different positions within the papermaking machines are required to perform different functions. Because papermaking rolls can have many different performance demands, and because replacing an entire metallic roll can be quite expensive, many papermaking rolls include a polymeric cover that surrounds the circumferential surface of a typically metallic core. By varying the material employed in the cover, the cover designer can provide the roll with different performance characteristics as the papermaking application demands. Also, repairing, regrinding or replacing a cover over a metallic roll can be considerably less expensive than the replacement of an entire metallic roll. Exemplary polymeric materials for covers include natural rubber, synthetic rubbers such as neoprene, styrene-butadiene (SBR), nitrile rubber, chlorosulfonated polyethylene (“CSPE”—also known under the trade name HYPALON® from DuPont), EDPM (the name given to an ethylene-propylene terpolymer formed of ethylene-propylene diene monomer), polyurethane, thermoset composites, and thermoplastic composites.

In many instances, the roll cover will include at least two distinct layers: a base layer that overlies the core and provides a bond thereto; and a topstock layer that overlies and bonds to the base layer and serves the outer surface of the roll (some rolls will also include an intermediate “tie-in” layer sandwiched by the base and top stock layers). The layers for these materials are typically selected to provide the cover with a prescribed set of physical properties for operation. These can include the requisite strength, elastic modulus, and resistance to elevated temperature, water and harsh chemicals to withstand the papermaking environment. In addition, covers are typically designed to have a predetermined surface hardness that is appropriate for the process they are to perform, and they typically require that the paper sheet “release” from the cover without damage to the paper sheet. Also, in order to be economical, the cover should be abrasion- and wear-resistant.

As the paper web is conveyed through a papermaking machine, it can be very important to understand the pressure profile experienced by the paper web. Variations in pressure can impact the amount of water drained from the web, which can affect the ultimate sheet moisture content, thickness, and other properties. The magnitude of pressure applied with a roll can, therefore, impact the quality of paper produced with the paper machine.

Other properties of a roll can also be important. For example, the stress and strain experienced by the roll cover in the cross machine direction can provide information about the durability and dimensional stability of the cover. In addition, the temperature profile of the roll can assist in identifying potential problem areas of the cover.

It is known to include pressure and/or temperature sensors in the cover of an industrial roll. For example, U.S. Pat. No. 5,699,729 to Moschel et al. describes a roll with a helically-disposed fiber that includes a plurality of pressure sensors embedded in the polymeric cover of the roll. In the past, typically sensors used with rolls covers were fiber optic sensors (see, for example, U.S. Pat. No. 6,429,421 to Meller et al. for exemplary fiber optic sensors). However, it can be difficult under certain circumstances to produce and receive consistent signals given the thickness of the covers and the sensitivity of the fiber optic sensors and the optical fibers running to the sensors. Also, the optical fibers routed between the sensors can be brittle, so placement of them in a cover during manufacture can be difficult. In addition, electrical sensors positioned on the core of the roll (beneath the base layer of the cover) typically require electrical insulation and can cause failure of the core-cover bond, which failure can be catastrophic for the cover. In contrast, sensors positioned on top of the base are sufficiently insulated, but are subject to malfunction due to water permeation in the topstock of the cover. Some piezoelectric sensors have been proposed, but many of these have been unsuitable due to their inability to function reliably in the desired temperature range (i.e., the temperature above which proposed piezoelectric materials lose reliable piezoelectric behavior, also known as the Curie temperature, has been too low).

### SUMMARY OF THE INVENTION

The present invention can address some of the issues raised by prior industrial rolls. As a first aspect, embodiments of the present invention are directed to an industrial roll, comprising: a substantially cylindrical core having an outer surface; a polymeric cover circumferentially overlying the core outer surface, the cover including a base layer circumferentially overlying the core and a topstock layer overlying the base layer; and a sensing system. The sensing system comprises: a plurality of piezoelectric sensors embedded in the cover base layer, the sensors configured to sense pressure experienced by the roll and provide signals related to the pressure; and a processor operatively associated with the sensors that processes signals provided by the sensors. In this configuration, piezoelectric sensors, which are typically more rugged than fiber optic sensors, can be employed, and some of the issues with previously used piezoelectric sensors can be addressed.

As a second aspect, embodiments of the present invention are directed to a method of constructing an industrial roll, the steps of: providing a substantially cylindrical core having an outer surface; applying a base layer of a polymeric cover that circumferentially overlies the core outer surface; embedding a plurality of piezoelectric sensors in the base layer, the sensors being configured to sense pressure experienced by the roll and provide signals related to the pressure; and applying a topstock layer of the polymeric cover that circumferentially overlies the base layer. In some embodiments, the base layer comprises an inner base layer and an outer base layer, and embedding of the sensors comprises applying the sensors to the inner base layer prior the application of the outer base layer.

### BRIEF DESCRIPTION OF THE FIGURES

FIG. 1 is a gage view of a roll and detecting system of the present invention.

FIG. 2 is a gage perspective view of a shell and an inner base layer formed in the manufacture of the roll of FIG. 1.

FIG. 3 is a gage perspective view of grooves being formed with a lathe in the inner base layer of FIG. 3.

FIG. 4 is a greatly enlarged gage view of an exemplary sensor and attached cables for a roll of FIG. 1.

FIG. 5 is a gage perspective view of the outer base layer being applied over the inner base layer, cables and sensors of FIGS. 2 and 4.

FIG. 6 is a gage perspective view of the topstock layer being applied over the outer base layer of FIG. 5.

### DETAILED DESCRIPTION OF EMBODIMENTS OF THE INVENTION

The present invention will be described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items. Where used, the terms “attached”, “connected”, “interconnected”, “contacting”, “coupled”, “mounted,” “overlying” and the like can mean either direct or indirect attachment or contact between elements, unless stated otherwise.

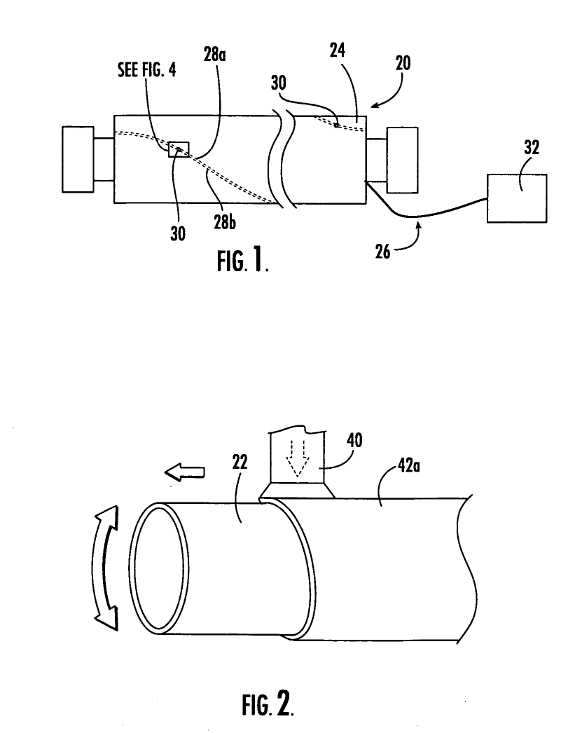

Referring now to the figures, a roll, designated broadly at 20, is illustrated in FIG. 1. The suction roll 20 includes a hollow cylindrical shell or core 22 (see FIG. 2) and a cover 24 (typically formed of one or more polymeric materials) that encircles the core 22. A sensing system 26 for sensing pressure, temperature, moisture, or some other operational parameter of interest includes a pair of leads 28a, 28b and a plurality of piezoelectric sensors 30, each of which is embedded in the cover 24. As used herein, a sensor being “embedded” in the cover means that the sensor is either entirely contained within the cover, and a sensor being “embedded” in a particular layer or set of layers of the cover means that the sensor is entirely contained within that layer or set of layers. The sensing system 26 also includes a processor 32 that processes signals produced by the piezoelectric sensors 30.

The core 22 is typically formed of a corrosion-resistant metallic material, such as stainless steel or bronze. The core 22 can be solid or hollow, and if hollow may include devices that can vary pressure or roll profile.

The cover 24 can take any form and can be formed of any polymeric and/or elastomeric material recognized by those skilled in this art to be suitable for use with a roll. Exemplary materials include natural rubber, synthetic rubbers such as neoprene, styrene-butadiene (SBR), nitrile rubber, chlorosulfonated polyethylene (“CSPE”—also known under the trade name HYPALON), EDPM (the name given to an ethylene-propylene terpolymer formed of ethylene-propylene diene monomer), epoxy, and polyurethane. In many instances, the cover 24 will comprise multiple layers. FIGS. 2, 5 and 6 illustrate the application of an inner base layer 42a, an outer base layer 42b and a topstock layer 70; additional layers, such as a “tie-in” layer between the outer base and topstock layers 42b, 70 and an adhesive layer between the shell 22 and the inner base layer 42a, may also be included. The cover 24 may also include reinforcing and filler materials, additives, and the like. Exemplary additional materials are discussed in U.S. Pat. Nos. 6,328,681 to Stephens and 6,375,602 to Jones and U.S. Patent Publication No. 20040053758, the disclosures of each of which are hereby incorporated herein in their entireties.

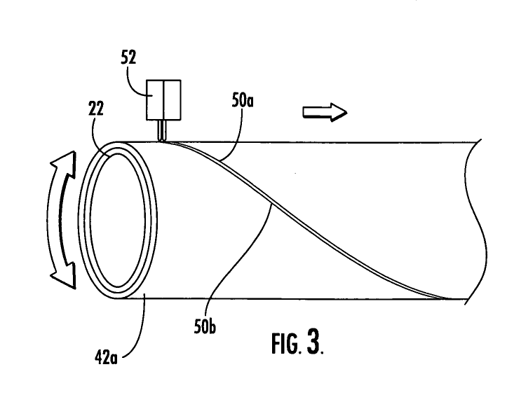

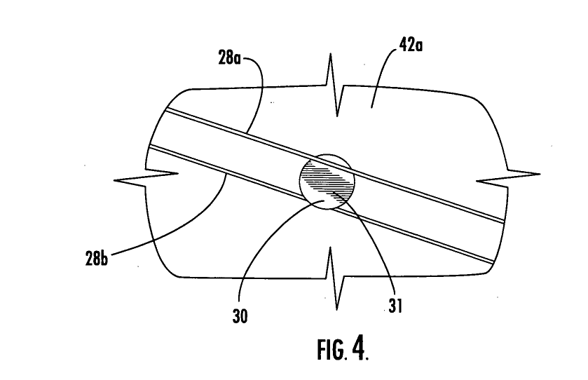

Referring now to FIG. 4, the piezoelectric sensors 30 of the sensing system 26 can take any shape or form recognized by those skilled in this art as being suitable for detecting pressure. Piezoelectric sensors can include any device that exhibits piezoelectricity when undergoing changes in pressure, temperature or other physical parameters. “Piezoelectricity” is defined as the generation of electricity or of electrical polarity in dielectric crystals subjected to mechanical stress, or other generation of stress in such crystals subjected to an applied voltage, the magnitude of such electricity or electrical polarity being sufficient to distinguish it from electrical noise. Exemplary piezoelectric sensors include piezoelectric sensors formed of piezoelectric ceramic, such as PZT-type lead-zirgonate-titanate, quartz, synthetic quartz, tourmaline, gallium ortho-phosphate, CGG (Ca₃Ga₂Ge₄O₁₄), lithium niobate, lithium tantalite, Rochelle salt, and lithium sulfate-monohydrate. In particular, the sensor material can have a Curie temperature of above 350° F., and in some instances 600° F., which can enable accurate sensing at the temperatures often experienced by rolls in papermaking environments. A typical outer dimension of the sensor 30 (i.e., length, width, diameter, etc.) is between about 2 mm and 20 mm, and a typical thickness of the sensor 30 is between about 0.002 and 0.2 inch.

In the illustrated embodiment, the sensors 30 are round; however, other shapes of sensors and/or apertures may also be suitable. For example, the sensor 30 itself may be square, rectangular, circular, annular, triangular, oval, hexagonal, octagonal, or the like. Also, the sensors 30 may be solid, or may include an internal or external aperture, (i.e., the aperture may have a closed perimeter, or the aperture may be open-ended, such that the sensor 30 takes a “U” or “C” shape). In addition, a continuous measurement sensor, such as a piezoelectric cable, may also be employed.

In the illustrated embodiment, the sensors 30 are distributed around the circumference of the roll 20 such that they are generally circumferentially equidistant from each other, but other arrangements may be employed, including those in which the sensors are (a) parallel with the axis of the roll, (b) positioned at the same axial location on the roll, (c) randomly scattered, or (d) some combination of the above arrangements. Also, in the illustrated embodiment, the sensors 30 define no more than a single revolution about the axis of the roll, but arrangements may also be suitable in which the sensors defined multiple revolutions of a helix about the roll, as illustrated in U.S. Patent Publication No. 2004-0053758, the disclosure of which is hereby incorporated herein in its entirety.

Referring again to FIG. 4, the leads 28a, 28b of the sensing system 26 can be any signal-carrying members recognized by those skilled in this art as being suitable for the passage of electrical signals in a suction roll. In the illustrated embodiment, the lead 28a passes below the illustrated piezoelectric sensor 30 on one transverse edge thereof, and the lead 28b passes above the piezoelectric sensor 30 on a diametrically opposed transverse edge thereof. This arrangement is followed for each of the piezoelectric sensors 30. Alternatively, the leads may be positioned on the same surface of the sensor 30. As another alternative, the sensor 30 may have “wings” extending radially outwardly from the edge of the sensor that contact the leads. As still another alternative, a wireless system, such as that described in co-pending and co-assigned U.S. patent application Ser. No. 10/977,948, filed 29 Oct. 2004 and entitled Wireless Sensors in Roll Covers, may be employed; the disclosure of this patent application is hereby incorporated herein in its entirety.

Referring once again to FIG. 1, the processor 32 is typically a personal computer or similar data exchange device, such as the distributive control system of a paper mill, that is operatively associated with the sensors 30 and that can process signals from the sensors 30 into useful, easily understood information. It is preferred that a wireless communication mode, such as RF signaling, be used to transmit the data collected from the sensors 30 to the processing unit 32. Other alternative configurations include slip ring connectors that enable the signals to be transmitted from the sensors 30 to the processor 32. Suitable exemplary processing units are discussed in U.S. Pat. Nos. 5,562,027 to Moore and 6,752,908 to Gustafson et al. and U.S. patent application Ser. No. 10/977,948, filed 29 Oct. 2004 and entitled Wireless Sensors in Roll Covers, the disclosures of each of which are hereby incorporated herein in their entireties.

The roll 20 can be manufactured in the manner described below and illustrated in FIGS. 2-6. In this method, initially the core 22 is covered with a portion of the cover 24 (such as the inner base layer 42a). As can be seen in FIG. 2, the inner base layer 42a can be applied with an extrusion nozzle 40, although the inner base layer 42a may be applied by other techniques known to those skilled in this art. Typically the inner base layer 42a is formed of rubber or epoxy-based composite materials, and has a thickness of between about 0.030 and 0.350 inches.

Turning now to FIG. 3, a pair of continuous helical grooves 50a, 50b are cut into the inner base layer 42a with a cutting device, such as the lathe 52 illustrated herein. The grooves 50a, 50b are formed at a depth of about 0.010 inches (it should be deep enough to retain the leads 28a, 28b therein), and may make one or more than one full revolution of the outer surface of the inner base layer 42a as desired

Referring now to FIG. 4, after the grooves 50a, 50b are formed in the inner base layer 42a, the leads 28a, 28b and sensors 30 of the sensor system 26 are installed. The leads 28a, 28b are helically wound within respective grooves 50a, 50b, with the sensors 30 being positioned closely adjacent to desired locations. The leads 28a, 28b are retained within the grooves 50a, 50b and are thereby prevented from side-to-side movement.

Once the sensors 30 are in desired positions, they can be adhered in place. This may be carried out by any technique known to those skilled in this art; an exemplary technique is adhesive bonding.

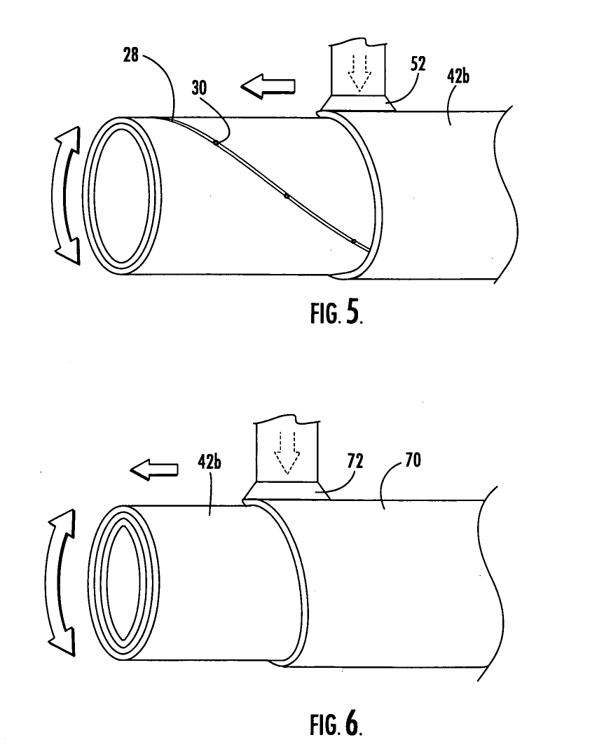

Referring now to FIG. 5 and 6, once the sensors 30 and leads 28a, 28b have been positioned and affixed to the inner base layer 42a, the remainder of the base layer 42 (i.e., the outer base layer 42b) is applied. FIG. 5 illustrates the application of the outer base layer 42b via an extrusion nozzle 52, although those skilled in this art will appreciate that the application of the outer base layer 42b can be carried out by any technique recognized as being suitable for such application. In a typical roll, the outer base layer 42b is formed of rubber or epoxy-based composite materials and has a thickness of between about 0.030 and 0.350 inches, such that the sensors 30 are embedded in the base layer 42. Also, typically the outer base layer 42a will be formed of the same material as the inner base layer 42a.

Because the piezoelectric sensors 30 are applied over the inner base layer 42a rather than directly to the core 22, they can be applied without temperature insulation. As such, the bond at the interface between the base layer 42 and the core 22 is not compromised by the presence of the sensors 30, with the result that the risk of failure of this bond (and, in turn, the risk of catastrophic failure of the cover) is significantly reduced. In addition, the application of the outer base layer 42b over the sensors 30 can reduce the impact of water permeation through the topstock layer 70. Thus, placement of the sensors 30 within the base layer 42 can address both of these issues experienced by previous sensors in roll covers.

As noted above, the present invention is intended to include rolls having covers that include only a base layer and top stock layer as well as rolls having covers with additional intermediate layers. Any intermediate layers would be applied over the outer base layer 42b prior to the application of the topstock layer 70.

Turning now to FIG. 6, the topstock layer 70 is applied over the outer base layer 42b. The topstock layer 70 is typically formed of rubber or polyurethane, and may be applied via any technique known to those skilled in this art to be suitable for the application of a polymeric layer, although FIG. 6 illustrates application via an extrusion nozzle 72. The topstock layer 70 is typically a polymeric material that has a hardness that is lower than that of the base layer 42. The topstock layer 70 is ordinarily between about 0.200 and 4.00 inches. Application of the top stock layer 70 is followed by curing, techniques for which are well-known to those skilled in this art and need not be described in detail herein.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. An industrial roll, comprising:
a substantially cylindrical core having an outer surface and an internal lumen;
a polymeric cover circumferentially overlying the core outer surface, the cover including a base layer circumferentially overlying the core and a topstock layer overlying the base layer; and
a sensing system comprising:
a plurality of piezoelectric sensors embedded in the cover base layer, the sensors configured to sense pressure experienced by the roll and provide signals related to the pressure; and
a processor operatively associated with the sensors that processes signals provided by the sensors.

2. The industrial roll defined in claim 1, wherein the sensing system further comprises two electrical leads that interconnect each of the plurality of sensors.

3. The industrial roll defined in claim 2, wherein one of the electrical leads contacts a top surface of one of the sensors, and the other of the electrical leads contacts a bottom surface of that sensor.

4. The industrial roll defined in claim 1, wherein the piezoelectric material comprises piezoelectric ceramic.

5. The industrial roll defined in claim 1, wherein the piezoelectric material has a Curie temperature of at least 350° F.

6. The industrial roll defined in claim 1, wherein the base layer includes an inner base layer and an outer base layer, and wherein the sensors are disposed to overlie the inner base layer and underlie the outer base layer.

7. The industrial roll defined in claim 1, wherein the base layer comprises a rubber or an epoxy-based composite material.

8. The industrial roll defined in claim 1, wherein the topstock layer is formed of a material selected from the group consisting of: rubber; polyurethane and epoxy.

9. The industrial roll defined in claim 1, wherein the inner base layer has a thickness of between about 0.030 and 0.350 inches, and the outer base layer has a thickness of between about 0.030 and 0.350 inches.

10. The industrial roll defined in claim 1, wherein the topstock layer has a thickness of between about 0.200 and 4.0 inches.

11. A method of constructing an industrial roll capable of detecting pressure experienced by the roll, the method comprising the steps of:
providing a substantially cylindrical core having an outer surface;
applying a base layer of a polymeric cover that circumferentially overlies the core outer surface;
embedding a plurality of piezoelectric sensors in the base layer, the sensors being configured to sense pressure experienced by the roll and provide signals related to the pressure; and
applying a topstock layer of the polymeric cover that circumferentially overlies the base layer.

12. The method defined in claim 11, wherein the step of applying the base layer comprises applying an inner base layer over the shell and applying an outer base layer over the inner base layer, and the step of embedding the sensors comprises attaching the sensors to the inner base layer prior to the application of the outer base layer.

13. The method defined in claim 11, wherein the base layer comprises a rubber or an epoxy-based composite material.

14. The method defined in claim 11, wherein the topstock layer is formed of a material selected from the group consisting of: rubber; polyurethane and epoxy.

15. The method defined in claim 11, wherein the piezoelectric material comprises piezoelectric ceramic.

16. The method defined in claim 11, wherein the piezoelectric material has a Curie temperature of at least 350° F.

17. The method defined in claim 11, wherein the inner base layer has a thickness of between about 0.030 and 0.350 inches, and the outer base layer has a thickness of between about 0.030 and 0.350 inches.

18. The method defined in claim 11, wherein the topstock layer has a thickness of between about 0.200 and 4.0 inches.
